(19) United States
(12) Patent Application Publication
(10) Pub. No.: US 2012/0089479 A1
(43) Pub. Date: Apr. 12, 2012

(54) Electronic system and method for providing beauty solutions

(76) Inventor: Suzanne Felando Mattson, SanDiego, CA (US)

(21) Appl. No.: 13/317,065

(22) Filed: Oct. 6, 2011

Related U.S. Application Data
(60) Provisional application No. 61/404,689, filed on Oct. 7, 2010.

(51) Int. Cl. G06Q 30/02

(52) U.S. Cl. 705/26.7

(57) ABSTRACT

The present invention is directed to an electronic system and method for providing beauty solutions and/or treatments, when trying to cure beauty problems. The electronic system and method can provide useful information on hair solutions and recommend products, allowing a user to select a beauty treatment regime based on the user's present beauty problems and a variety of additional selection criteria.

### RELATED APPLICATIONS

This application claims priority from U.S. Provisional Patent Application No. 61/404,689, filed on Oct. 7, 2010, titled, “Electronic System and Method for Providing Beauty Solutions” the content of which is incorporated herein by reference.

### FIELD OF INVENTION

The present invention relates generally to an electronic system and method regarding beauty products and their applications. More particularly, but not exclusively, the present invention relates to an electronic system and method which facilitates the selection of a solution and/ or treatment and recommends products based upon a plurality of selection criteria, with the primary criteria being the overall price of the treatment in relation to the consumer's budget.

### BACKGROUND OF THE INVENTION

At some point in every person's life they have had a beauty crisis. If not a beauty crisis than at least a beauty problem for example, a bad hair day. Hair problems seem to be a persistent, evasive issue for most women and even men. Hair can be damaged, too flat, too thin, too frizzy, unmanageable, too short, falling out, greasy or just too dry. Or a person may have skin or make-up problems for example blemishes or black circles under the eyes or skin that is too dry or rather too oily. Beauty issues may be intermittent or may also change over time. Some people only need a temporary fix for their beauty problem while others are looking for more permanent long term solutions.

All the information a person may need to solve their beauty problems may be available through several sources such as the internet, friendly advice, aesthetician, hairdresser, make-up counter, books, magazine articles and so on. However these options may be time consuming, provide inaccurate or incorrect information, unattainable goals due to budget constraints or even worse harmful recommendations. This invention is a comprehensive resource in a single convenient location, namely a novel electronic system and method for providing beauty solutions and treatments to consumers based on a price they can afford.

### SUMMARY OF THE INVENTION

Various exemplary embodiments as described herein addresses the desirable aspects lacking in the relevant art and provides in various exemplary systematic, methodic, and electronic embodiments for a system and method directed toward selecting a treatment and/or providing a solution for a consumer's beauty problem based on a plurality of selection criteria including primarily the price of the products and the individual budget of the consumer.

This invention is based, at least in part, on a valuable proprietary computer database and/or server containing beauty care product profiles and pricing information. This database can provide treatment regimes to consumers in that it can be used to select beauty products that have been researched to determine their application, value, efficacy, usage, therapeutic effect, and most importantly cost.

Another embodiment of the present invention, is a method to determine the appropriate beauty products based on a particular concern or symptom. The consumer can access the database of beauty product information, review the treatment recommendation or recommendations and select a regime based on a minimum of selection criteria.

In yet another embodiment of the present invention the consumer can select a solution or treatment that is most appropriate for their budget. Most often consumers require product information and/or recommendations that are most relevant to the price the can afford. The products can be sorted and categorized based on price. This will provide the consumer an option to select a treatment based on individual or overall price.

Another embodiment of the present invention is a computer interface wherein a consumer can interact with an Internet website to access the system and method contained in said database and/or server.

In another embodiment of the present invention the consumer can access the system and method contained in the database and/or server of beauty product information and solutions through an electronic device such as, for example, a desktop computer or a handheld electronic device.

In yet another embodiment of the present invention is to provide different information from a variety of beauty care professionals. For example the integrated application can connect to servers available from one or more salons or industry experts to receive data reflecting their recommendations.

In another embodiment, the database includes a list of treatments and/or solutions for hair problems. This list of treatments and/or solution can come from experts in the industry, such as hairdressers, product recommendations, and consumer ratings based on performance.

In another embodiment, the database includes a list of treatments and/or solutions for skin problems. This list of treatments and/or solution can come from experts in the industry, such as aestheticians, product recommendations, and consumer ratings based on performance.

In another embodiment, the database includes a list of treatments and/or solutions for make-up problems. This list of treatments and/or solution can come from experts in the industry, such as make-up artists, product recommendations, and consumer ratings based on performance.

In another embodiment the database and/or server can include products which may be organized into various segments. The various segments may be organized by types of beauty products and their applications. The products that may be maintained by the database is almost limitless including both commercial products intended for beauty care and maintenance as well as home remedies.

It is contemplated that any method, system or information described herein can be implemented with respect to any other method, system or information described herein.

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents and other references mentioned herein, are incorporated by reference in their entirety. In case of conflict, the present specification, including definitions will control.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIG. 1 is a schematic view of a block diagram of a computer system.

FIG. 2 is a schematic view of a networked arrangement in which a consumer can interact with the systems and methods described herein.

FIG. 3 is a schematic view of an illustrative electronic device for providing access to the systems and methods described herein in accordance with some embodiments of the invention.

FIG. 4 is a schematic view of several situations where a consumer can make use of the systems and methods described herein in accordance with some embodiments of the invention.

FIG. 5 illustrates a block diagram illustrating some embodiments of the invention.

FIG. 6 is a schematic view for functions available to a consumer in accordance with some embodiments of the invention.

FIG. 7 illustrates a block diagram illustrating an example of the systems and methods described herein in accordance with some embodiments of the present invention.

### DETAILED DESCRIPTION OF THE INVENTION

The present invention relates to electronic system and method for addressing beauty problems by providing solutions and/or treatments to the end user based on a plurality of selection criteria. The present invention will be described in relation to beauty products. However, it will be appreciated that, with minor modifications, the system and method may be adapted for use with any products that may be purchased by a consumer when the cost of the overall products is a primary concern.

In one embodiment the electronic system and method will be described as being accessed and operated through the Internet via a website accessible by consumer through a standard internet browser. In various exemplary embodiments, a database and/or server is maintained, generally accessible by a public network.

Where necessary computer programs algorithms and routines are envisioned to be programmed in a high level language object oriented language for example JAVA, C, C++, C#, COBRA, AWK, PERL, VISUAL BASIC. Database components may utilize any common database program by way of example and not limitation ORACLE, SEQUEL Server, MySQL, SQL, MS ACCESS, DB2, MS FOXBASE, DBASE, PostgreSQL, and RBASE.

For purposes of this specification the term “program” is intended to be interpreted in its broadest sense to include all instructions executable by a processor whether embodied in hardware or software. Where applicable references to various programs may be made in both singular and plural form. No limitation is intended by such grammatical usage as one skilled in the art will appreciate that multiple programs, objects, subprograms and subroutines, algorithms, applets, contexts, etc., may be implemented programmatically to implement the various inventive embodiments.

### Hardware System Configuration

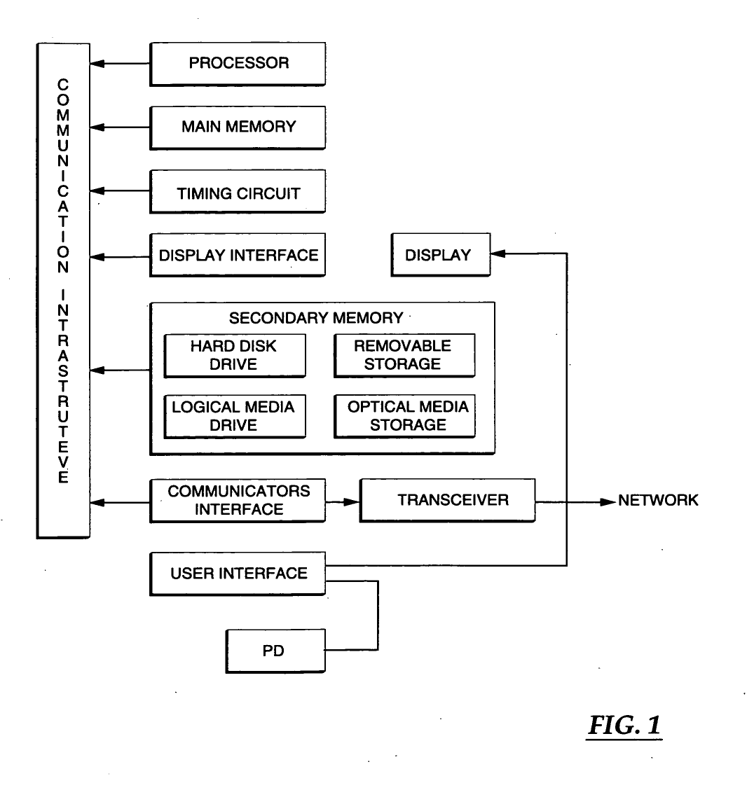

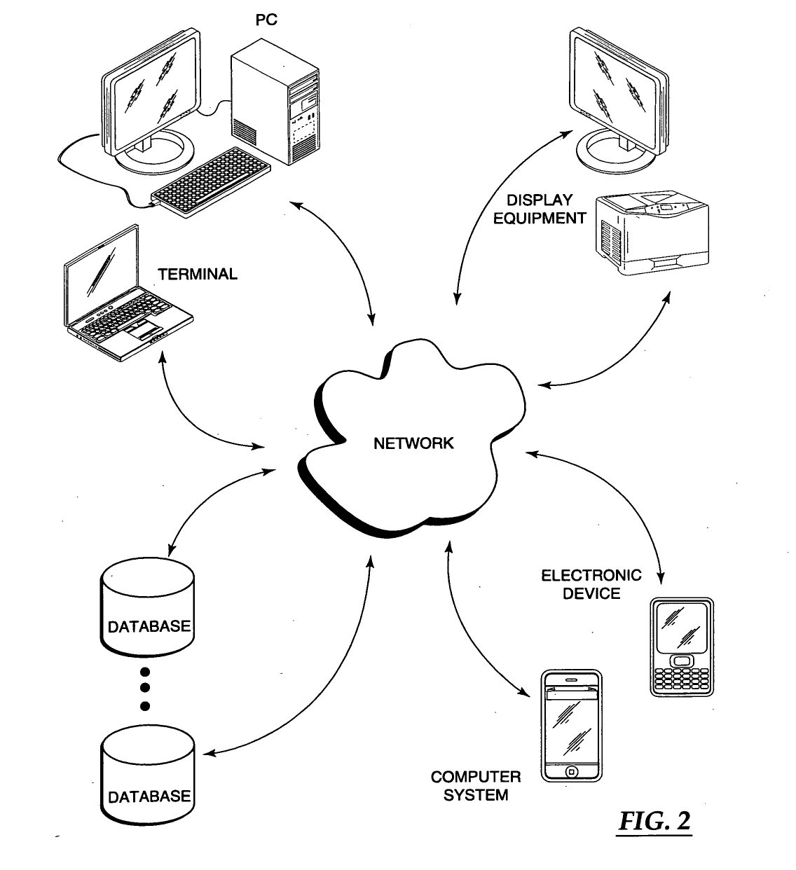

Referring to FIG. 1 a generalized block diagram of an exemplary computer system is depicted. The computer system is illustrative of a server and a plurality of networked clients (FIG. 2). For simplicity and ease of understanding the term “networked server” will be used hereinafter. However the same general computer configurations apply to the networked clients as well.

The networked server includes a communication infrastructure used to transfer data and memory addresses where data files are to be found and control signals among the various components and subsystems associated with the networked server. As such the communications infrastructure provides the input output (I/O) between and among the various components and subsystems associated with the networked server.

A processor is provided to interpret and execute logical instructions stored in the memory. One skilled in the art will appreciate that one or more processors may be provided in various server implementations and/or in multicore integrated processor packages.

The main memory is the primary general purpose storage area for instructions and data to be processed by the processor. The term “memory” is to be interpreted in its broadest sense and includes both main memory and secondary memory. A collective term of “computer readable storage medium” may be used to describe either or both the main memory and the secondary memory as well.

Where applicable reference to the term “datastore” should be interpreted as an alternative to the terms “memory” and computer readable storage medium.” The memory includes the primary and secondary memory. A timing circuit is provided to coordinate programmactic activities within the computer in near real time. The timing circuit may be used as a watchdog timer, clock, or a counter arrangement and may be separately programmable.

The processor main memory and timing circuit are directly coupled to the communications infrastructure. A display interface is provided to drive a display associated with the networked server. The display interface is electrically coupled to the communications infrastructure and provides signals to the display for visually outputting both graphical displays and alpha numeric characters.

The display interface may include a dedicated graphics processor and memory (not shown) to support the displaying of graphics intensive media. The display may be of any type (eg. Cathode ray tube, gas plasma) but in most circumstances will be a solid state devices such as a liquid crystal display (LCD). A secondary memory subsystem is provided which houses retrievable data storage units hard disc drive an optional removable storage drive and an optional optical media storage drive.

The removable storage drive may be a replaceable hard drive, optical media drive or solid state flash RAM device. The logical media storage drive may include a RAM flash device or a EEPROM encoded with instructions executable by the processor. The optical storage media storage drive includes the ability to read and write compact discs (CD) and digital video media disc (DVD) form factors.

A communications interface subsystem is provided which allows for standardized electrical connections of peripheral devices to the communications infrastructure including PS/2, serial, parallel, USB, and Firewire connectivity ports.

For example, a communications network transceiver and a user interface may be electrically coupled to the communications infrastructure via the communications interface. The transceiver facilitates the remote exchange of data between the networked server and other devices in networked communications with the networked server. The transceiver is envisioned to be of type normally associated with a computer.

Alternatively, digital cellular communications formats compatible with evolving cellular standards, both peer to peer and client server arrangements are envisioned for implementation of the various exemplary embodiments.

For purposes of this specification the term “user interface” includes the hardware and software by which a user interacts with the networked server and the means by which the networked server conveys information to the user. The user interface may include a pointing device such as a mouse, a thumb wheel, a track ball or a touch screen, a sliding or circular potentiometer control, a push button or a switch.

The user interface provides interrupt signals to the processor via the communication s interface and communication infrastructure that may be used to interpret user interaction with the networked server. The networked server provides an operating system the necessary hardware and software, necessary to fully utilize the devices coupled to the communications infrastructure and at least an internet browser. The internet browser may be of any common type which is compatible with the operating system installed on the networked server.

### Network Topography

The network server may be in a networking arrangement in networking communications with one or more browser enabled client computer systems. The networked server includes a database engine operatively loaded into the memory of the networked server. The database engine is functionally coupled to at least a single database. The at least single database includes information about hair products including but not limited to, their applications, efficacy, price and recommendations for certain hair problems.

The user may be access the networked server via a private internet, a peer to peer communication, or a public network for example the internet using a local browser application installed on the user computer.

### Electronic Device

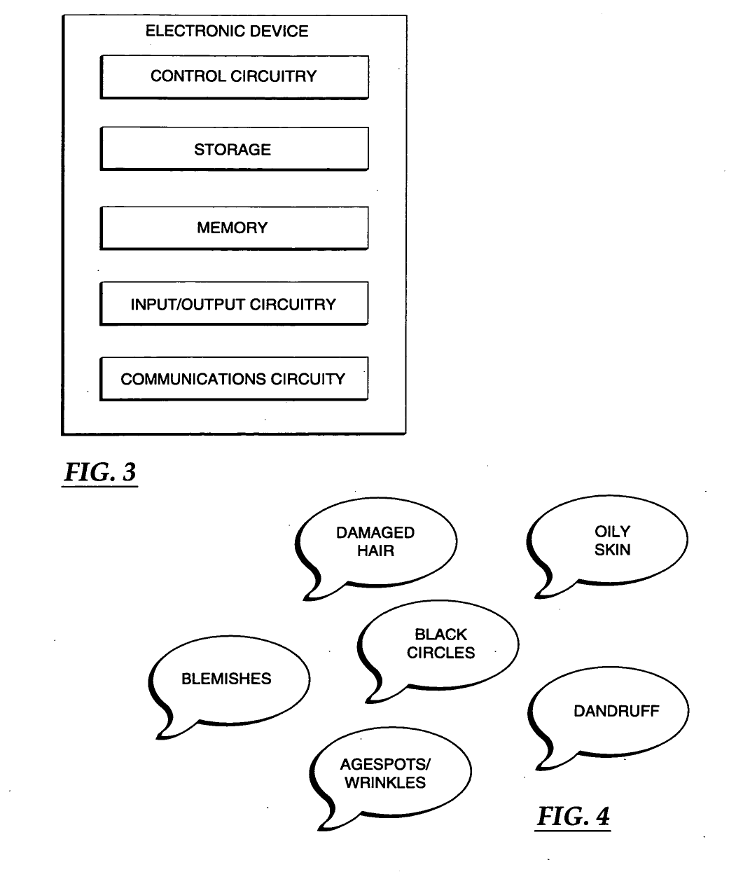

Referring now to FIG. 3 an electronic device may be used for providing an application operative to interface with the systems and methods in accordance with some embodiments of the invention. The term “electronic device” should be interpreted to its broadest possible meaning. The electronic device can include control circuitry, memory, input output circuitry (I/O) and communications circuitry.

In some embodiments one or more of the components of the electronic device can be combined or omitted (eg. Storage and memory may be combined). In some embodiments the electronic device may include components not combined or shown in FIG. 3 (eg. Motion detection components, power supply, display, camera, input mechanism, etc.).

The electronic device can be any suitable electronic device. For example, electronic devices can include a portable devices that his or her person may hold in his hand, such as a digital media player, an iPod™, iPad™, a personal email device such as a Blackerry™, a personal data assistant PDA, a cellular telephone, a handheld gaming device and a digital camera. The electronic device may also be a portable laptop computer or alternatively a fixed electronic device such as a desktop computer.

Control Circuitry can include any processing circuitry or processor operative to control the operations and performance of the electronic device. For example, the control circuitry can be used to run operating system applications, firmware application, media playback application, media editing applications, or any other application. In some embodiments, the control circuitry can drive a display and process inputs received from a user interface.

Storage can include for example one or more storage mediums including a hard rive, solid state drive, flash memory such as ROM any other suitable type of storage component, or any combination thereof. Storage can store for example media data, application data, firmware, user preference information data, authentification information, lifestyle information data, hair information data, product information data, transaction information data, wireless connection information data, contact information data, and any other suitable data or any combination thereof.

Memory can include cache memory, semi permanent memory such as RAM, and/or one or more different types of memory used for temporarily storing data. In some embodiments, memory can also be used for storing data to operate electronic device applications, or any other type of data that can be stored in storage. In some, embodiments, memory and storage can be combined as a single storage medium.

Input/ Output (I/O) circuitry can be operative to convert analog signals and other signals, into digital data. In some embodiments, I/O circuitry can also convert digital data into any other type of signal and vice versa. For example, I/O circuitry can receive and convert physical signals (from a touch screen), physical movements (from a mouse or sensor), analog audio signals or any other input. The digital data can be provided to and received from control circuitry, storage, memory or any other component of electronic device, several instances of control circuitry can be included in electronic device.

Electronic device can include any suitable interface or component for allowing a user to provide inputs to I/O circuitry. For example, the electronic device can include any suitable input mechanism such as for example a button, keypad, a dial, click wheel or a touch screen. In some embodiments electronic device can include a capacitive sensing mechanism or a multi touch capacitive sensing mechanism.

In some embodiments the electronic device can include specialized output circuitry associated with output devices, such as, for example, one or more audio outputs. The output can include one or more speakers built into the electronic device, or an audio component that is coupled to the electronic device (headset, headphones connected via a wire or wirelessly).

In some embodiments I/O circuitry can include display circuitry (screen/or project system) for providing a display visible to users. For example the display circuitry can include a screen, (an LCD screen) that is incorporated in electronic device. As another example the display circuitry can include a movable display or a projecting system for providing display of content on a surface remote from electronic device. In some embodiments the display circuitry can include a coder/decoder (CODEC) to convert digital meda data into analog signals. For example the display circuitry or their appropriate circuitry within electronic dievcie can include video CODECs, audio CODECs, or any other suitable type of CODEC.

The display circuitry can also include display driver circuitry, circuitry for driving display drivers, or both. The display circuitry can be operative to display content under the direction of control circuitry. Alternatively the display circuitry, can operative to provide instructions to a remote display.

Communications circuitry can include an suitable communication circuitry operative to connect to a communications network and to transmit communications from electronic device to other devices within the communications network. Communications circuitry can bee operative to interface with the communication network using any suitable communications protocol, such as , for example, WiFi, Bluetooth, radio frequency, infrared, GSM, GSM plus EDGE, CDMA, quadband, and other cellular protocols, VOIP, or any other suitable protocol.

In some embodiments, a communications circuitry can be operative to create a communications network using any suitable communications protocol. For example, communications circuitry can create a shot range communications network using a short range communications protocol to connect to other devices. For example communication circuitry can be operative to create a local communications network using the Bluetooth™ protocol to couple ele9ctronic device with a Bluetooth™ headset.

Electronic device can include one or more instances of communications circuitry for simultaneously performing several communications operations using different communication networks. Fore example electronic device can include a first instance communications circuitry for communicating over a cellular network and a second instance of communications circuitry for communicating over WiFi or using Bluetooth™. In some embodiments the same instances of communications circuitry can be operative to provide for communication over several communications networks.

In some embodiments electronic device can be coupled to a host device for data transfers, synching the communications device, software or firmware updates, providing performance information to a remote source, or performing any other suitable operation that can require electronic device to be coupled to a host device. Several electronic devices can be coupled to a single host device using the host device as a server. Alternatively or additionally, electronic device can be coupled to several host devices (eg. for each of the plurality of host devices to serve as a backup for data stored in electronic device.

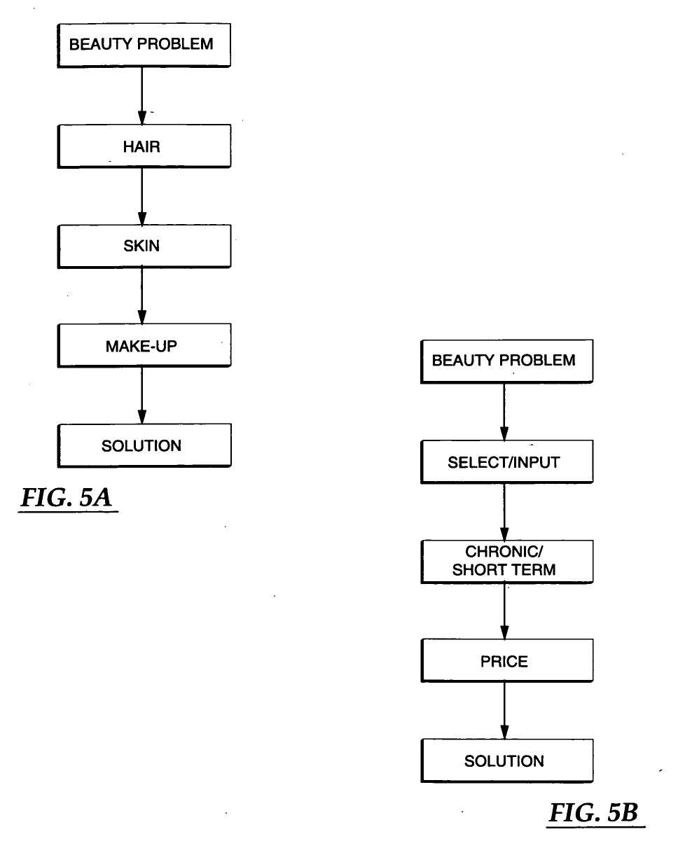

Referring now to FIG. 4 a schematic view of several situations in which a user may interact with the system in accordance with some embodiments of the invention. For example, the system may provide the user with product recommendations of what products to use for any given beauty problem. Moreover through the system the user can compare several solutions and/or treatments based on several price points.

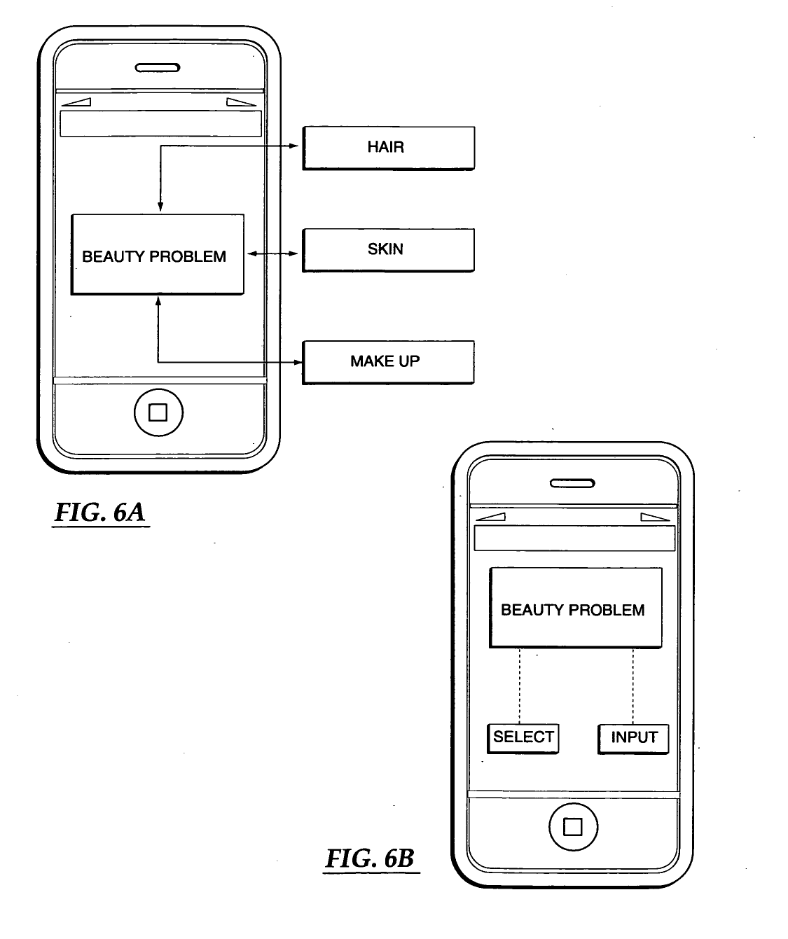

Referring now to FIG. 5, illustrates how the user or consumer can interact with the electronic interface be it an internet website or an electronic handheld device to select a beauty problem and later a beauty solution. The beauty problem can be a hair, skin or make-up concern of the user. In one embodiment the user can select a problem from a list of predetermined common beauty problems. The user can view more detail about the beauty problem by selecting a beauty problem from the list and expanding the profile. Alternatively the user may input the beauty problem by typing in key words or phrases into the electronic device. The user may also indicate whether the problem is short term or long term. This indication may be represented by any means to show frequency.

Often times a consumer is most concerned with the cost of the treatment. Whether it is a one time cost or the total cost of the treatment over time. A person's individual budget can be most important when selecting a solution for their beauty problems. Referring now to FIG. 5B in one embodiment the user can view possible beauty solutions prior to viewing the price or cost of the solutions. The user can also be given a period of time in which the treatment can work. By having a period of time allotted for the treatment the user or alternatively the system can calculate the total cost of treatment over time.

For the price conscious consumer there can be a summary option that can provide the overall cost for the treatment or solutions over a period of time. This can be a one time solution or the solution may take multiple applications over a period of time. This summary will provide consumers the ability to budget the appropriate amount for the solution.

In another embodiment the user can view and select a price point or budget prior to viewing the beauty solutions. Referring now to FIG. 5C the price point or budget can be represented in any way to show a value range of least expensive options to most expensive options. The system can provide the best available option for the user given the budgetary constraint. For example, this can be accomplished by a dollar range or dollar signs. Alternatively, price may not be an important option to the user. The user can also select that price is not an option.

In another embodiment the system can provide consumers with the predicted results of the selected treatment options. This will provide the consumer with expected results or rather the return on their investment in the beauty solution. For example, an expensive solution that can be recommended for a consumer is a cosmetic procedure such as Botox™. The user will be given a period of time for which the treatment will show the desired result. For example, Botox™ can provide a rather quick result at a higher price than other long term cheaper solutions. There can be rare situations when a user may need to seek medical advice regarding their beauty problem. Seeking the advice of a medical professional will also be a solution within the system's capabilities.

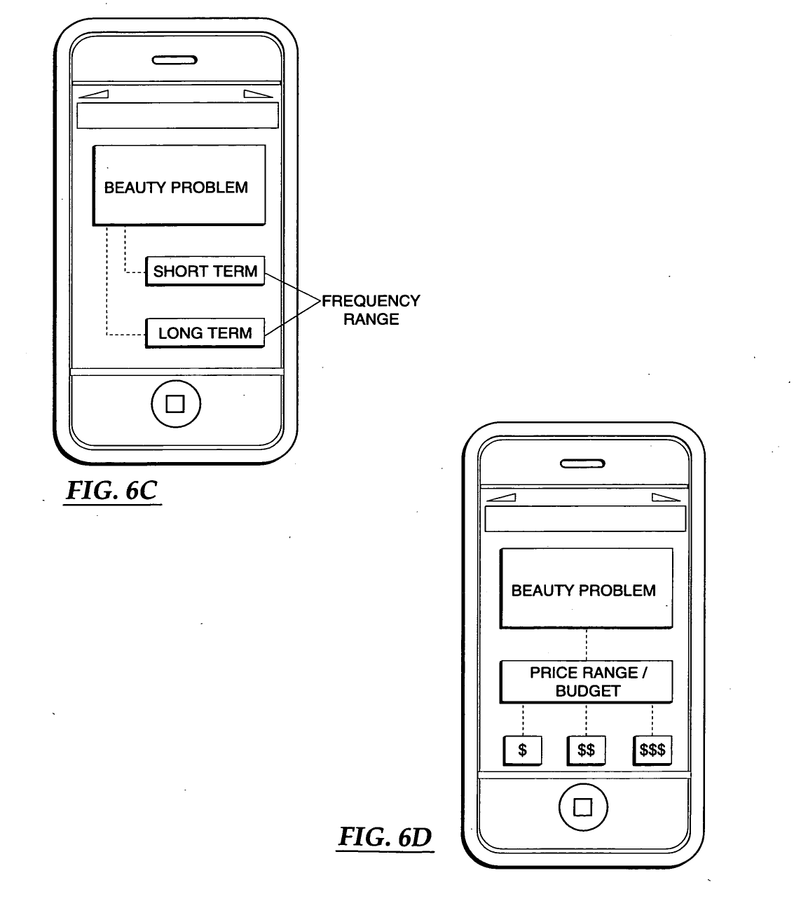

Referring now to FIG. 6 which illustrates some embodiments of the present invention when the user is using a handheld electronic device. The illustrations are for example purposes only. It is contemplated and well within the spirit of the invention that the interface may have several features that are not included in said illustrations.

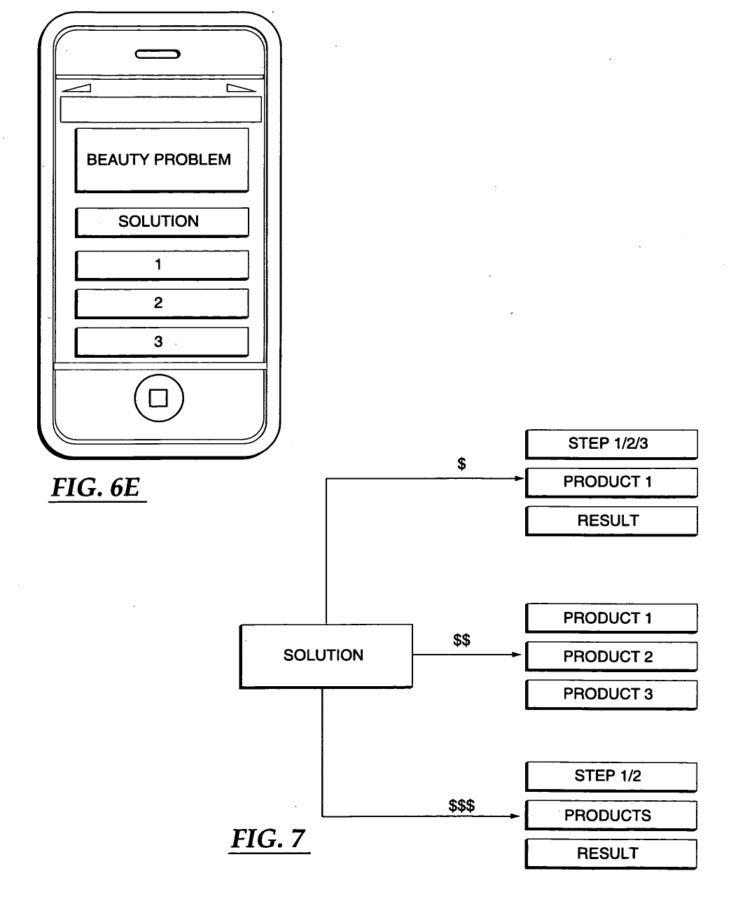

Referring now to FIG. 7, a block diagram illustrating solutions based on a predetermined price range. For any given price range or price category there may be a single product recommended to multiple products. There may be a single step or multiple steps ranging from a single application to multiple applications over time. The depth of the solution can depend on the term of the problem. In another embodiment at each phase or point in time for that solution the system can provide the intended result after the completion of a single step or phase in the overall treatment process.

It is also contemplated that a user can triage or sort the beauty solutions based upon criteria that are important to the user. For example at any point in time during this selection process, (e.g.. prior to selecting a beauty problem or at the end of the process when solutions are provided) the user may additionally sort the solutions based on criteria that are important or specific to them. For example the user may only want to use “green” products so that the system will only select products that are environmentally friendly. Another example would be hair solutions such as shampoos and the user does not want parabens in their shampoo. Another example would be the user has hard water and requires solutions that work with hard water. The amount of ways to sort the data in the system is limitless in that any grouping of solutions is possible.

### Materials and Methods

Methods and materials are described herein. However, methods and materials similar or equivalent to those described herein can be also used to obtain variations of the present invention. The materials, methods, and examples are illustrative only and not intended to be limiting.

### Incorporation by Reference

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

### Other Embodiments

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of providing an individualized beauty solutions, comprising:
receiving from an individual a first selection criteria from a pluarality of selection criteria; and
generating a set of individualized beauty solutions from a plurality of beauty solutions within a category, said generating comprising inputting said first selection criteria into an electronic device, said electronic device processing said selection criteria to generate output information, said output information comprising the set of said individualized beauty solutions.

2. The method in claim 1 wherein said output information can be further processed by said individual inputting into said electronic device subsequent selection criteria from a plurality of selection criteria.

3. The method of claim 1 wherein said first selection criteria is based on a monetary amount said individual desires to spend on said beauty solution.

4. The method of claim 2 wherein said subsequent selection criteria is based on a monetary amount said individual desires to spend on said beauty solution.

5. An electronic system for generating individualized beauty solutions, comprising:
an interface for receiving from an individual selection criteria from a plurality of selection criteria;
a database for storing and processing said plurality of selection criteria said database comprising beauty care products, profiles, recommendations and pricing information; and
an output device for communicating said database information to said individual based on said selection criteria.
